(19) United States
(12) Patent Application Publication
(10) Pub. No.: US 2025/0383073 A1
(43) Pub. Date: Dec. 18, 2025

(54) LIGHT DISTRIBUTION METHOD AND APPARATUS FOR LIGHTING LAMP

(71) Applicant: Shenzhen Supersun, Shenzhen (CN)

(72) Inventors: Lizhen Wang, Shenzhen (CN); Mingxia Hou, Shenzhen (CN)

(21) Appl. No.: 18/885,784

(22) Filed: Sep. 16, 2024

(30) Foreign Application Priority Data
Jun. 17, 2024 (CN) 202410779282.3

(51) Int. Cl. F21V 23/04; F21V 5/00; F21V 7/00; F21Y 105/16

(52) U.S. Cl. CPC F21V 23/0435; F21V 5/007; F21V 7/0066; F21Y 2105/16

(57) ABSTRACT

The invention belongs to the technical field of illumination, and discloses a light distribution method and apparatus for a lighting lamp. The lighting lamp in the light distribution method for the lighting lamp includes at least two light distribution lenses, and each light distribution lens emits the same or different light spots. According to the invention, through various different target light distribution lenses, the luminous angle and the luminous intensity of each lens can be adjusted according to the actual needs, so that the lighting lamp can flexibly adapt to different application scenes, to realize various lighting effects.

### CROSS REFERENCE TO RELATED APPLICATIONS

This application claims priority to Chinese Patent Application No. 202410779282.3, filed with the China National Intellectual Property Administration on June 17, 2024 and entitled "LIGHT DISTRIBUTION METHOD AND APPARATUS FOR LIGHTING LAMP", which is incorporated herein by reference in its entirety.

### TECHNICAL FIELD

The invention relates to the technical field of illumination, in particular to a light distribution method and apparatus for a lighting lamp.

### BACKGROUND

The existing lighting lamps adopt uniform light distribution design, namely lenses of a lighting lamp generally adopt only one lens type for light distribution. Due to design of the fixed-type lenses, only single luminous angle output can be achieved and the output light type can only be a fixed light type, so that the luminous angles of the fixed-type lenses and the light type are preset and cannot be adjusted according to the actual needs, and thus the adaptability of the lighting lamps in different application scenes is greatly limited. Moreover, due to incapability of flexibly adjusting the light type and the luminous angles, in order to meet different lighting needs, a user may need to buy a variety of lighting lamps with different light types, so that the purchase cost and the maintenance cost are increased.

### SUMMARY

The main purpose of the application is to provide a light distribution method and apparatus for a lighting lamp, aiming at solving the technical problems of relatively poor flexibility and relatively high operating cost of the fixed light type output by the existing fixed-type lenses.

In order to achieve the purpose, the invention provides a light distribution method for a lighting lamp; the lighting lamp includes at least two light distribution lenses, and each light distribution lens emits the same or different light spots; and the light distribution method includes the following steps: acquiring a light distribution requirement needed by a target lighting area; selecting corresponding target light distribution lenses from the light distribution lenses based on the light distribution requirement; and controlling the luminous angle and/or the luminous intensity of each target light distribution lens according to the light distribution requirement to output a combined light type.

Further, a step of acquiring the light distribution requirement needed by the target lighting area comprises the following sub-steps: acquiring the purpose and the environmental characteristics of the target lighting area; determining a needed lighting effect according to the purpose and the environmental characteristics; and selecting the types and the number of the target light distribution lenses for the target lighting area based on the lighting effect.

Further, a step of controlling the luminous angle and/or the luminous intensity of each target light distribution lens according to the light distribution requirement comprises the following sub-steps: acquiring a light spot type, a lighting range and a brightness level that are needed based on the lighting effect; and controlling the luminous angle and/or the luminous intensity of each target light distribution lens based on the light spot type, the lighting range and the brightness level.

Further, a step of controlling the luminous angle and/or the luminous intensity of each target light distribution lens according to the light distribution requirement to output a combined light type comprises the following sub-steps:

setting a specific luminous angle parameter range and/or a specific luminous intensity parameter range for each target light distribution lens according to the light distribution requirement;

acquiring a target luminous angle parameter and/or a target luminous intensity parameter of the target light distribution lens within the luminous angle parameter range and/or the luminous intensity parameter range based on the environmental conditions and the usage scenes of the target lighting area; and

controlling the luminous angle and/or the luminous intensity of each target light distribution lens according to the target luminous angle parameter and/or the target luminous intensity parameter to enable each target light distribution lens to achieve the needed luminous effect in the target lighting area to generate the combined light type meeting the light distribution requirement.

The invention further provides a light distribution apparatus for the lighting lamp, which is used for implementing the light distribution method according to any one of the above; and the light distribution apparatus includes a lamp body, a control device and at least two light distribution lenses.

the light distribution lenses are arranged on one side, close to the target lighting area, of the lamp body, and each light distribution lens emits the same or different light spots; and

the control device is connected with the light distribution lenses, and is used for controlling the luminous angle and the luminous intensity of each target light distribution lens according to an actual light distribution requirement to output a combined light type.

Further, a light distribution lenses comprise a first-light-type light distribution lens and second-light-type light distribution lenses; and the first-light-type light distribution lens and the second-light-type light distribution lenses are arranged at intervals, so that the first-light-type light distribution lens and the second-light-type light distribution lenses are separated components.

Further, a light distribution lenses comprise a third-light-type light distribution lens and a fourth-light-type light distribution lens; the third-light-type light distribution lens and the fourth-light-type light distribution lens are connected; and the third-light-type light distribution lens and the fourth-light-type light distribution lens form an integrated component.

Further, a light distribution apparatus further comprises reflective baffles; the reflective baffles are movably connected at the corners between one sides, where the light distribution lenses are arranged, and the adjacent sides thereof; and the reflective baffles incline towards the directions away from the light distribution lenses.

Further, a first-light-type light distribution lens comprises a first circuit board, and a first lens and a plurality of first lighting lamp beads arranged in an array, which are connected to the first circuit board; the first circuit board is connected with the lamp body; the first lens is positioned on one side, far away from the lamp body, of the first circuit board; the first lighting lamp beads are positioned between the first circuit board and the first lens; and spherical convex lenses corresponding to the plurality of first lighting lamp beads are arranged on one side, far away from the first circuit board, of the first lens.

Further, a second-light-type light distribution lens includes a second circuit board, and a second lens and a plurality of second lighting lamp beads arranged in the width direction of the lamp body, which are connected to the second circuit board; the second circuit board is connected with the lamp body; the second lens is positioned on one side, far away from the lamp body, of the second circuit board; the second lighting lamp beads are positioned between the second circuit board and the second lens; and a strip-shaped convex lens corresponding to the second lighting lamp beads is arranged on one side, far away from the second circuit board, of the second lens.

### BENEFICIAL EFFECTS

The invention provides the light distribution apparatus for the lighting lamp; the lighting lamp includes at least two light distribution lenses, and each light distribution lens emits the same or different light spots; and the light distribution method includes the following steps: acquiring a light distribution requirement needed by a target lighting area; selecting corresponding target light distribution lenses from the light distribution lenses based on the light distribution requirement; and controlling the luminous angle and/or the luminous intensity of each target light distribution lens according to the light distribution requirement to output a combined light type; therefore, through various different target light distribution lenses, the luminous angle and the luminous intensity of each lens can be adjusted according to the actual needs, so that the lighting lamp can flexibly adapt to different application scenes, the applicability of the lighting lamp in various environments is greatly improved, and the output of various combined light types can be realized; thereby, a user can flexibly adjust the light types according to the specific lighting needs and various lighting effects can be realized without replacement of the whole lamp, and thus the purchase cost is reduced.

### BRIEF DESCRIPTION OF THE DRAWING

FIG. 1 is a schematic flow diagram for a light distribution method for a lighting lamp according to an embodiment of the invention;

FIG. 2 is an overall schematic diagram of a light distribution apparatus for the lighting lamp according to the embodiment of the invention;

FIG. 3 is a schematic light type diagram for the FIG. 2 according to the embodiment of the invention;

FIG. 4 is an A-light-type light distribution curve chart according to the embodiment of the invention;

FIG. 5 is an A-light-type light spot diagram for the FIG. 4 according to the embodiment of the invention;

FIG. 6 is a B-light-type light distribution curve chart according to the embodiment of the invention;

FIG. 7 is a B-light-type light spot diagram for the FIG. 6 according to the embodiment of the invention;

FIG. 8 is a C-light-type light distribution curve chart according to the embodiment of the invention;

FIG. 9 is a C-light-type light spot diagram for the FIG. 8 according to the embodiment of the invention;

FIG. 10 is an A+B+C-light-type combined light distribution curve chart according to the embodiment of the invention;

FIG. 11 is an A+B+C-light-type combined light spot diagram for the FIG. 10 according to the embodiment of the invention;

FIG. 12 is a light-type-overlapped curve chart according to the embodiment of the invention;

FIG. 13 is a light-type-overlapped light spot diagram for the FIG. 12 according to the embodiment of the invention;

FIG. 14 is a schematic diagram before and after light type occlusion according to the embodiment of the invention;

FIG. 15 is a schematic light type diagram before and after lens focus shift according to the embodiment of the invention;

FIG. 16 is an overall schematic diagram of a light distribution apparatus for the lighting lamp according to another embodiment of the invention;

FIG. 17 is a stereo diagram of light projection paths of the light types for the FIG. 16 according to the another embodiment of the invention;

FIG. 18 is a cross-sectional luminous angle view without light occlusion for the FIG. 16 according to the another embodiment of the invention; and

FIG. 19 is a cross-sectional luminous angle view with light occlusion for the FIG. 16 according to the another embodiment of the invention.

Reference numerals in the drawings are as follows:

1. Light distribution lenses; 2. Lamp body; 3. Reflective baffles;

10. First-light-type light distribution lens; 11. Two second-light-type light distribution lenses; 12. Third-light-type light distribution lens; 13. Fourth-light-type light distribution lens;

101. First circuit board; 102. First lens; 103. First lighting lamp beads;

110. Second circuit board; 111. Second lens; 112. Second lighting lamp beads;

120. Third circuit board; 121. Third lens; 122. Third lighting lamp beads; and

130. Fourth circuit board; 131. Fourth lens; 132. Fourth lighting lamp beads.

The purpose achievement, the functional characteristics and the advantages of the invention will be further described with reference to the attached drawings in combination with the embodiments.

### DESCRIPTION OF EMBODIMENTS

It should be understood that the specific embodiments described herein are only used for explaining the invention and are not used for limiting the invention.

In the description of the invention, it needs to be understood that orientation or position relationships indicated by terms, such as "center", "longitudinal", "transverse", "length", "width", "thickness", "upper", "lower", "front", "back", "left", "right", "vertical", "horizontal", "top", "bottom", "inside", "outside", "clockwise" and "counterclockwise", are the orientation or position relationships based on the drawings, which only provide the convenience in describing the invention and simplifying the description, but do not indicate or imply that the referred devices or components must have specific orientations and must be constructed and operated in the specific orientations, so that the orientation or position relationships cannot be understood as the limitation of the invention. In addition, terms "first" and "second" are only applied for descriptive purpose, and cannot be understood as indicating or implying the relative importance or implicitly indicating the number of the indicated technical characteristics. Thereby, the characteristics restricted as "first" and "second" characteristics can explicitly indicate or implicitly include one or more characteristics. In the description of the invention, "plurality" means two or more except for other clear and specific restrictions.

In the description of the invention, it should be explained that except for other clear regulations and restrictions, terms "arrangement", "mutual connection" and "connection", should be broadly understood; for example, fixed connection, detachable connection or integrated connection can be adopted; and mechanical connection, direct connection, indirect connection through a medium, internal connection of two components or interaction between the two components can also be accepted. The ordinary technicians in the field can understand the specific meanings of the above terms in the invention according to the specific situations.

In the invention, except for other clear regulations and restrictions, the orientation or position relationships that the first characteristics are "upper" or "lower" than the second characteristics can include the direct contact between the first and second characteristics, or contact through other characteristics therebetween without direct contact between the first and second characteristics. Moreover, the orientation or position relationships that the first characteristics are "upper" than, "above" and "on" the second characteristics include the situations that the first characteristics are directly and obliquely above the second characteristics, or only indicate that the horizontal heights of the first characteristics are bigger than those of the second characteristics. Moreover, the orientation or position relationships that the first characteristics are "lower" than, "below" and "under" the second characteristics include the situations that the first characteristics are directly and obliquely below the second characteristics, or only indicate that the horizontal heights of the first characteristics are smaller than those of the second characteristics.

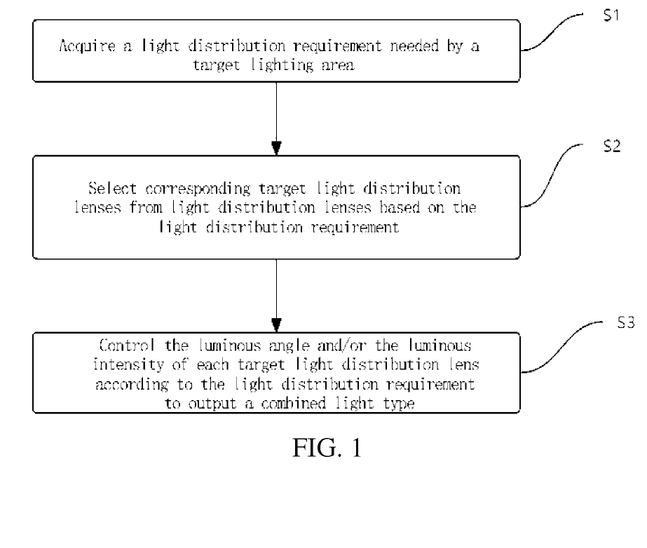

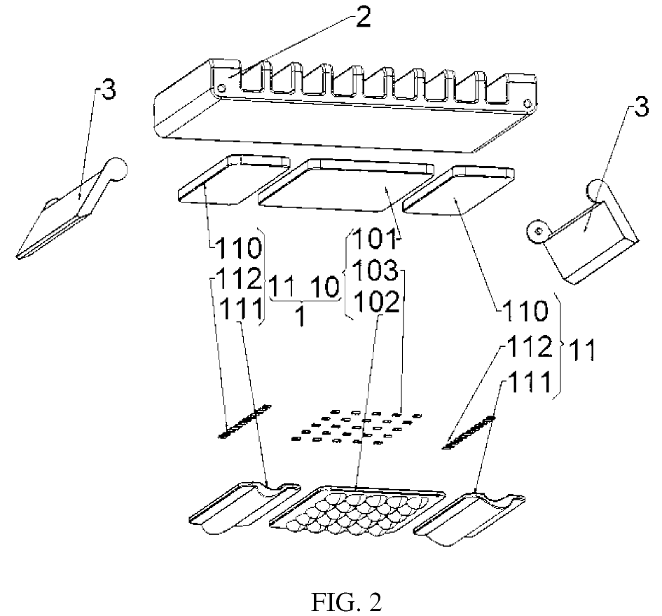

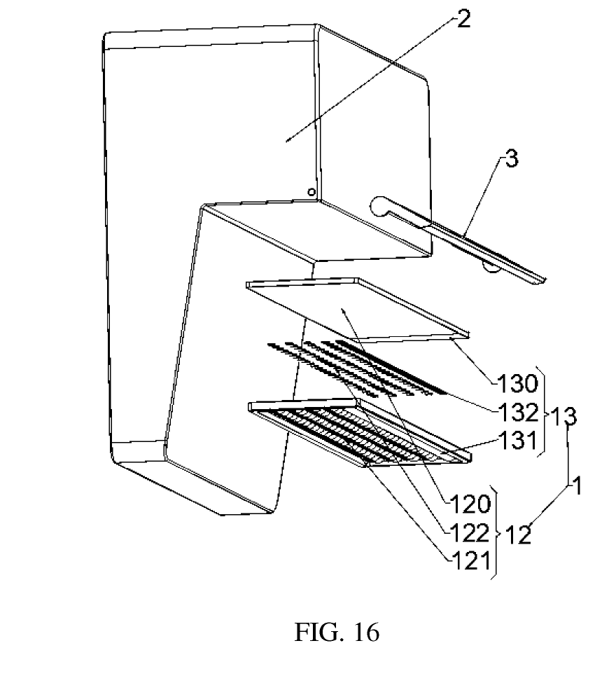

With reference to the FIG. 1, the FIG. 2 and the FIG. 16, the embodiment provides a light distribution method for a lighting lamp; the lighting lamp includes at least two light distribution lenses, and each light distribution lens emits the same or different light spots; and the light distribution method includes the following steps:

S1: acquiring a light distribution requirement needed by a target lighting area;

S2: selecting corresponding target light distribution lenses from the light distribution lenses based on the light distribution requirement; and

S3: controlling the luminous angle and/or the luminous intensity of each target light distribution lens according to the light distribution requirement to output a combined light type.

In the embodiment, according to the light distribution method for the lighting lamp, the light distribution lenses 1 with reflective concave surfaces consisting of a plurality of cambered lenses are used for reflecting and aggregating light of a light source; the lighting lamp includes at least two light distribution lenses, and each light distribution lens emits the same or different light spots; through optical principles and simulated experiments, the structure and the parameters of each light distribution lens 1 are determined to ensure that an expected luminous effect can be met; in addition, the light distribution lenses 1 are connected with a preset control system, the control system can be realized through communication control over the light distribution lenses 1 through adoption of a microcontroller or other programmable devices, and the user inputs specific light distribution requirements through an external controller, a smart phone application or a touch panel or other ways; the control system can acquire the light distribution requirement needed by the target lighting area; therein, the control system evaluates the size, the shape and the application of the target lighting area, measures the existing luminous conditions including the brightness, the color temperature and the uniformity, and determines the needed lighting effect achieved by parameters such as the brightness level, the color temperature range and the light distribution; according to the light distribution requirement, all the light distribution lenses 1 that may meet the needs are listed, the performance parameters of each light distribution lens 1, including the luminous angle, the luminous intensity and the light spot characteristics, are analyzed, corresponding target light distribution lenses are selected from the light distribution lenses 1, and the control system controls a rotating mechanism of each target light distribution lens according to the input of the user to realize the adjustment of the luminous angle; meanwhile, the control system can also adjust the current or the power of a lighting source to control the luminous intensity; at least two target light distribution lenses are selected to achieve the needed lighting effect; the layout and the arrangement mode of target light distribution lenses are designed through the control system to cover the target lighting area; the lighting effect is predicted by a computer simulation technology, and a scheme is optimized; the initial luminous angle and the initial luminous intensity of each target light distribution lens are determined according to a simulation result and the user feedback; the control system is used for adjusting the settings of each target light distribution lens in real time to optimize the lighting effect; an optical fiber sensor is used for monitoring the lighting effect to ensure that the light distribution requirement is met; the luminous angle and/or the luminous intensity of each target light distribution lens are dynamically adjusted according to a monitoring result and the environmental change; the plurality of target light distribution lenses are synchronously adjusted to output the needed combined light type; therefore, through various different target light distribution lenses, the luminous angle and the luminous intensity of each lens can be adjusted according to the actual needs, so that the lighting lamp can flexibly adapt to different application scenes, the applicability of the lighting lamp in various environments is greatly improved, and the output of various combined light types can be realized; thereby, the user can flexibly adjust the light types according to the specific lighting needs and various lighting effects can be realized without replacement of the whole lamp, and thus the purchase cost is reduced.

Furthermore, the control system can control the on-off switch combination of the light types of two or more target light distribution lenses and can also control the light-dark adjustment combination of the light types of the two or more target light distribution lenses; in addition, the control system can also control the two or more target light distribution lenses to obtain the needed light type output by means of focus shift; and by use of the control system, the user can select different target light distribution lens combinations according to the actual needs to obtain multiple light type outputs, so that the flexibility and the diversity of the lighting lamp in different application scenes are effectively improved.

In an embodiment, the step of acquiring a light distribution requirement needed by a target lighting area includes the following sub-steps:

S10: acquiring the purpose and the environmental characteristics of the target lighting area;

S11: determining a needed lighting effect according to the purpose and the environmental characteristics; and

S12: selecting the types and the number of the target light distribution lenses for the target lighting area based on the lighting effect.

In the embodiment, the environmental characteristic data of the target lighting area, such as the luminous intensity, the color temperature and the spatial layout, are automatically collected through a built-in or externally-connected sensor; the purpose information, which is input by the user or retrieved from a database, of the target lighting area is received; the collected environmental characteristic and purpose data are processed by a data analysis algorithm; key parameters of the lighting need are identified according to an analysis result; the lighting effects under different lighting conditions are simulated by using a built-in illumination simulation software; the needed lighting effect is predicted according to a simulation result; according to the predicted lighting effect, through a built-in algorithm of the control system, the types of the needed target light distribution lenses are determined and the number of the needed target light distribution lenses is calculated to meet the requirements on the lighting effect and the coverage range; and through acquirement of the specific application and environmental characteristics of the target lighting area, the lighting need can be more accurately matched, so that excessive illumination or insufficient illumination are avoided.

In an embodiment, the step of controlling the luminous angle and/or the luminous intensity of each target light distribution lens according to the light distribution requirement includes the following sub-steps:

S20: acquiring a light spot type, a lighting range and a brightness level that are needed based on the lighting effect; and

S21: controlling the luminous angle and/or the luminous intensity of each target light distribution lens based on the light spot type, the lighting range and the brightness level.

In the embodiment, the needed light spot type, such as spotlight, floodlight or specially-shaped light spot, is determined according to the lighting effect; the lighting range is defined to ensure the coverage of the target area and avoid overflowing; in addition, the brightness level is set to meet the visual need and consider the energy efficiency; according to the light spot type, the lighting range and the brightness level which are acquired, the appropriate models and types of the target light distribution lenses are selected; the control system is used for adjusting the luminous angle of each target light distribution lens, and specific operation may include the following sub-steps: adjusting the mechanical angle (rotation and inclination) of the lens, and changing the position or angle of an optical element to adjust the emission direction and the scattering angle of a light beam; based on the needed brightness level, the luminous intensity of each target light distribution lens is adjusted through adjustment of the current and the voltage of the lamp or by use of a dimmer; and a PWM (Pulse Width Modulation) technology or other dimming technologies can be adopted for precise control, so that the luminous angle and the luminous intensity of each target light distribution lens can be adjusted accurately according to the need on the lighting effect, and thus fine illumination control is realized.

In an embodiment, the step of controlling the luminous angle and/or the luminous intensity of each target light distribution lens according to the light distribution requirement to output a combined light type includes the following sub-steps:

S30: setting a specific luminous angle parameter range and/or a specific luminous intensity parameter range for each target light distribution lens according to the light distribution requirement;

S31: acquiring a target luminous angle parameter and/or a target luminous intensity parameter of the target light distribution lens within the luminous angle parameter range and/or the luminous intensity parameter range based on the environmental conditions and the usage scenes of the target lighting area; and

S32: controlling the luminous angle and/or the luminous intensity of each target light distribution lens according to the target luminous angle parameter and/or the target luminous intensity parameter to enable each target light distribution lens to achieve the needed luminous effect in the target lighting area to generate the combined light type meeting the light distribution requirement.

In the embodiment, the use purpose, the functional need and the environmental characteristics of the target lighting area are collected according to the light distribution requirement; the needed lighting effect including the brightness, the color temperature and the uniformity and the like is determined; the initial luminous angle parameter range and the initial luminous intensity parameter range are set for each target light distribution lens; based on a preset standard or empirical value, parameters are input into the control system for preliminary configuration; by use of a sensor or through manual measurement, real-time environmental data of the target area is collected; the usage scenes, such as the working time, the rest time or special activities, are analyzed to adjust a lighting strategy; the target luminous angle parameter and/or the target luminous intensity parameter of the target light distribution lens are/is acquired within the luminous angle parameter range and/or the luminous intensity parameter range according to the environmental conditions and the usage scenes; the control system is used for fine adjustment to adapt to different lighting needs and environmental changes and control the target light distribution lens in real time; according to the target luminous angle parameter and/or the target luminous intensity parameter, the luminous angle and/or the luminous intensity of each target light distribution lens are controlled; the sensor is used for monitoring the lighting effect to ensure that the lighting requirement of the target area is met; based on the luminous effect of each target light distribution lens, the overall effect of the combined light type is evaluated by comprehensively considering the lighting range and the brightness distribution of each lens; according to the actual effect and the user feedback, the combined light type is optimized and adjusted to ensure achievement of the needed luminous effect in the target lighting area, including the brightness uniformity, the color temperature and other aspects; and through comprehensive consideration of the lighting range and the brightness distribution of each lens, the combined light type that meets the light distribution requirement is generated, so that achievement of the needed lighting effect in the target lighting area is facilitated, the specific needs of the user are met, and the user satisfaction and the user loyalty are effectively improved.

With reference to the FIG. 2 and the FIG. 16, the invention further provides a light distribution apparatus for a lighting lamp, which is used for implementing the light distribution method described in the embodiment; the light distribution apparatus includes a lamp body 2, a control device and at least two light distribution lenses 1;

the light distribution lenses 1 are arranged on one side, close to the target lighting area, of the lamp body 2, and each light distribution lens 1 emits the same or different light spots; and

the control device is connected with the light distribution lenses 1, and is used for controlling the luminous angle and the luminous intensity of each light distribution lens 1 according to an actual light distribution requirement to output a combined light type.

In the embodiment, the light distribution apparatus for the lighting lamp includes the lamp body 2, the control device, reflective baffles 3 and at least two light distribution lenses 1; the light distribution lenses 1 are arranged on one side, close to the target lighting area, of the lamp body 2; the light distribution apparatus is provided with at least two different light distribution lenses 1; each lens can independently output a specific light spot shape; through optical principles and simulated experiments, the structure and the parameters of each light distribution lens 1 are determined to ensure that an expected luminous effect can be met; the control device is arranged inside the lamp body 2 and is electrically connected with the light distribution lenses 1; the control system can receive the light distribution requirement input by the user and control the luminous angle and the luminous intensity of each light distribution lens 1 according to the requirement; the control system can be realized through communication control over the light distribution lenses 1 through adoption of a microcontroller or other programmable devices; the user inputs specific light distribution requirements through an external controller, a smart phone application or a touch panel or in other ways; the control system controls a rotating mechanism of each target light distribution lens 1 according to the input of the user to realize the adjustment of the luminous angle; meanwhile, the control system can also adjust the current or the power of a lighting source to control the luminous intensity; the user can choose to install different light distribution lenses 1, and the control system can simultaneously control the luminous angles and the luminous intensities of all the light distribution lenses 1 according to the selection and input of the user to achieve the expected combined light type effect; therefore, through a variety of light distribution lenses 1 with different designs, the luminous angle and the luminous intensity of each lens can be adjusted according to the actual needs, so that the lighting lamp can flexibly adapt to different application scenes, the applicability of the lighting lamp in various environments is greatly improved, and the output of various combined light types can be realized; thereby, the user can flexibly adjust the light types according to the specific lighting needs and various lighting effects can be realized without replacement of the whole lamp, and thus the purchase cost is reduced.

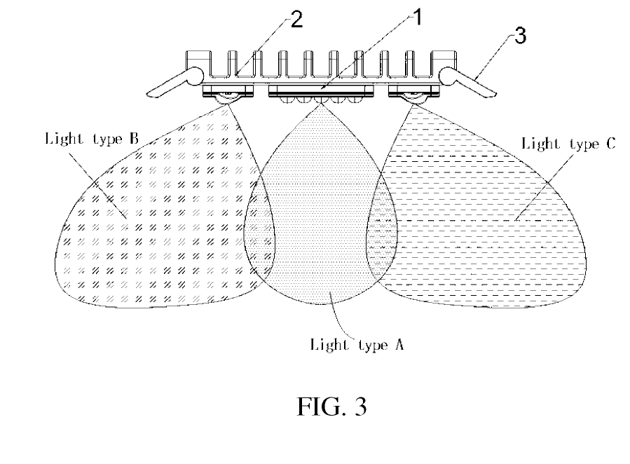

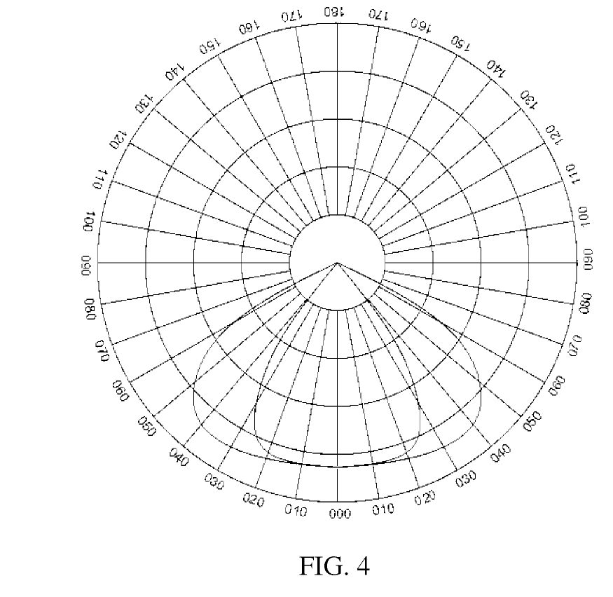

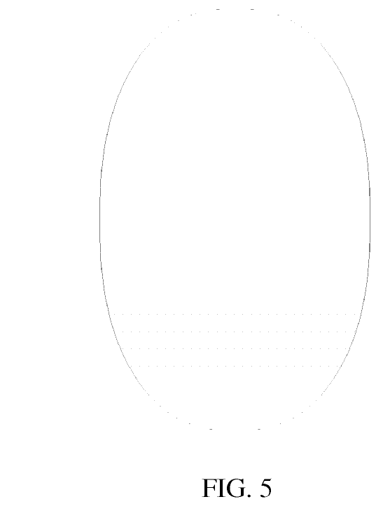

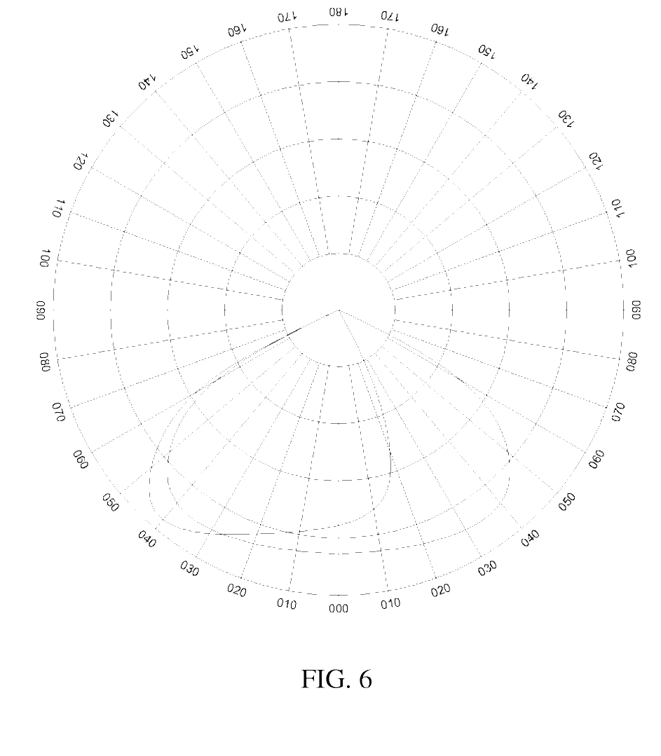

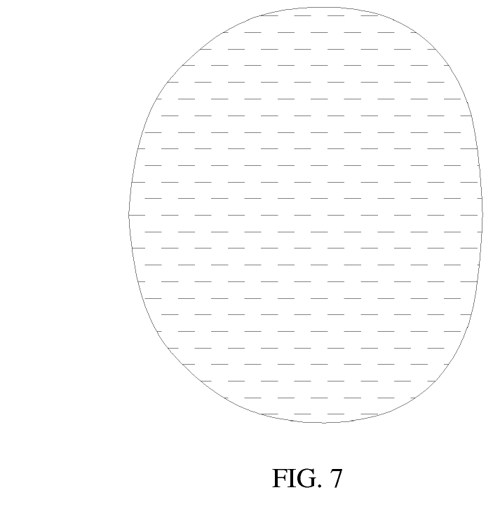

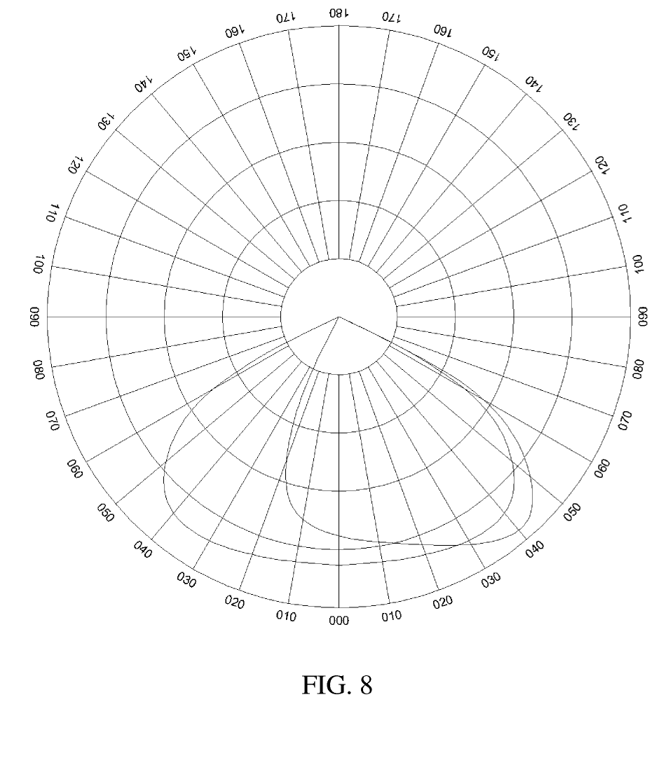

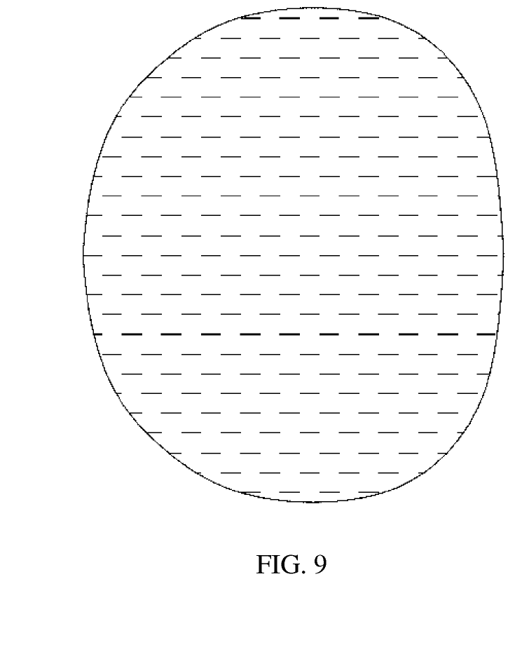

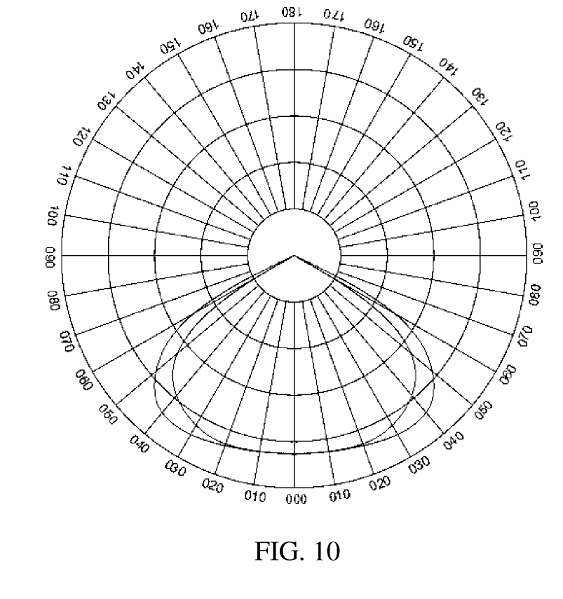

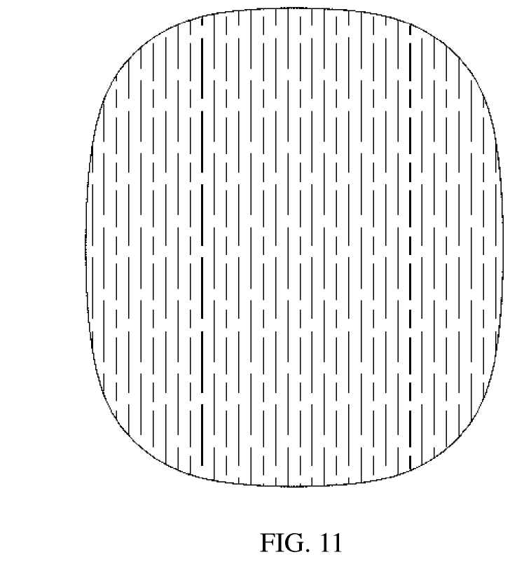

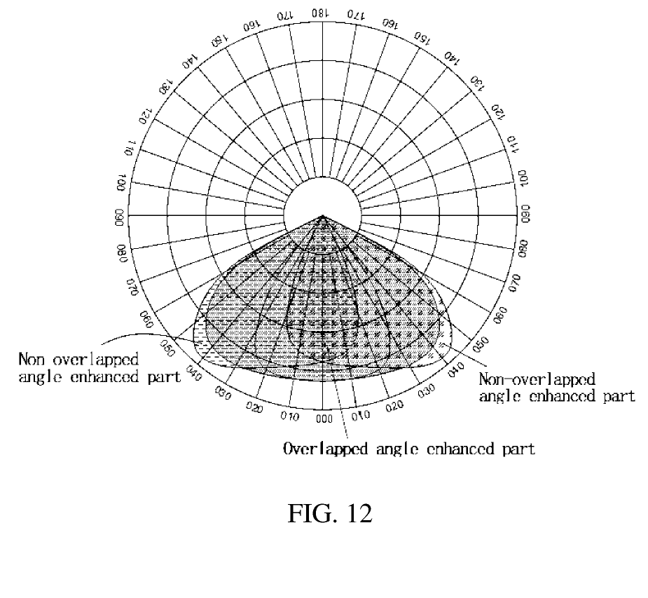

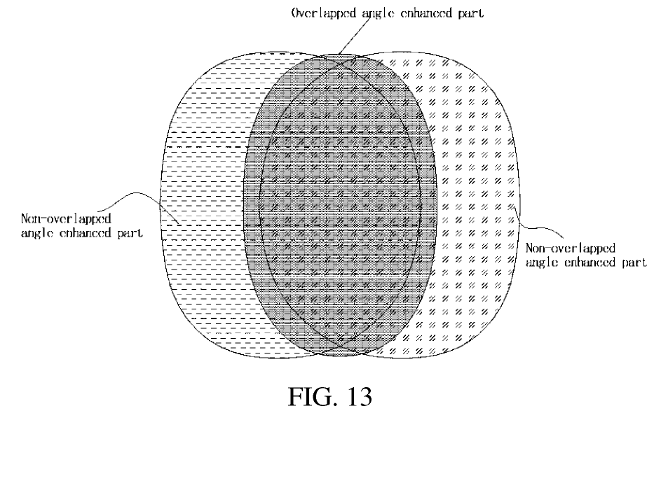

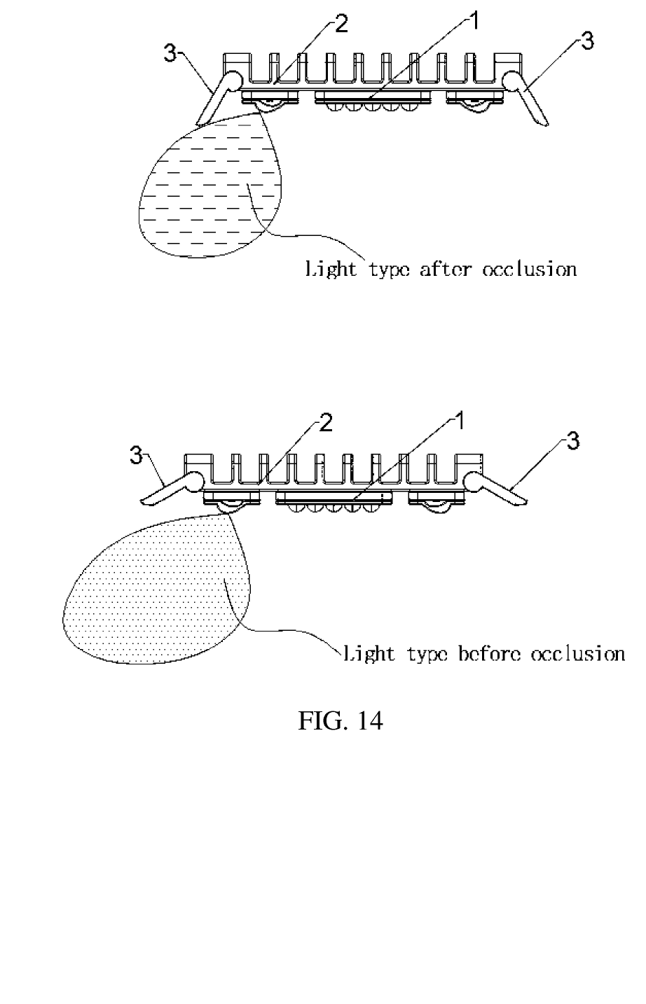

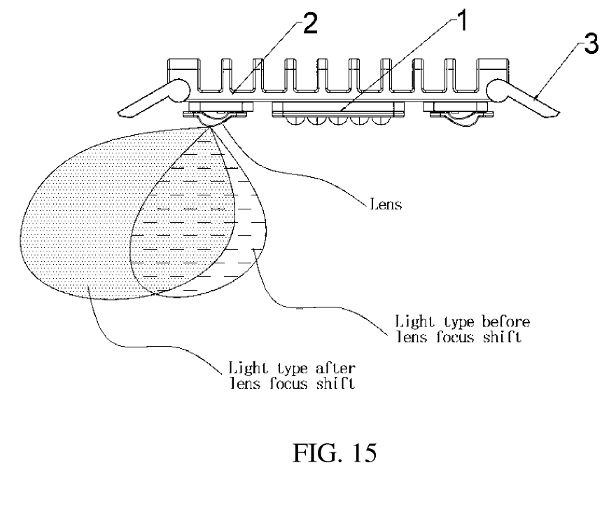

With reference to the FIG. 2-15, in an embodiment, the light distribution lenses 1 include a first-light-type light distribution lens 10 and two second-light-type light distribution lenses 11; and the first-light-type light distribution lens 10 and the second-light-type light distribution lenses 11 are arranged at intervals, so that the first-light-type light distribution lens 10 and the second-light-type light distribution lenses 11 are separated components.

In the embodiment, the light distribution lenses 1 include the first-light-type light distribution lens 10 and the second-light-type light distribution lenses 11; the first-light-type light distribution lens 10 and the second-light-type light distribution lenses 11 can emit a plurality of the same or different light spots respectively; therein, in an exemplary embodiment, one first-light-type light distribution lens 10 and two second-light-type light distribution lenses 11 are provided, the first-light-type light distribution lens 10 is arranged between the two second-light-type light distribution lenses 11, the first-light-type light distribution lens 10 is respectively distant from the two second-light-type light distribution lenses 11 at an equal interval distance, and the first-light-type light distribution lens 10 and the second-light-type light distribution lenses 11 are arranged in an adjacent manner, so that the first-light-type light distribution lens 10 and the two second-light-type light distribution lenses 11 form three separated components; and in addition, the size of the first-light-type light distribution lens 10 is bigger than those of the second-light-type light distribution lenses 11, so that the lighting dead angle is effectively reduced, light in a lighting coverage area is ensured to be more uniform, the overall lighting efficiency is improved and the energy waste.is reduced.

Furthermore, when the first-light-type light distribution lens 10 emits A-light-type light and the two second-light-type light distribution lenses 11 emit B-light-type light and C-light-type light respectively, the combination ways of the first-light-type light distribution lens 10 and the two second-light-type light distribution lenses 11 include but are not limited to a light type A+B, a light type A+C, a light type B+C and a light type A+B+C; therein, A, B and C represent different light distribution lenses 1; when the light type A is a symmetrical elliptical light spot, the light type B is a specially-shaped light spot shifted to the left and the light type C is a specially-shaped light spot shifted to the right, the light types A, B and C are combined to obtain a combined light distribution curve; moreover, the shapes of the light types are different from one another, so that complete overlapping between the light types cannot be achieved, a non-overlapped position is a part with an increased angle after complementation and an overlapped position is a part with an enhanced angle after the complementation; a larger oval light spot is obtained through the complementation of multiple light types; further, the light distribution curve and the light spot after combination have certain shape distortion and a combination result is not simply equal to an overlapping and mapping result of the light types A, B and C, which is due to deformation caused by the local angle enhancement caused by some light overlapping of the combined light type, thus resulting in the angle distortion of the combined result under the influence of the light intensity; based on this characteristic, the angle change is not only controlled by a simple on-off switch, but also influenced by the local light intensity, so that the purpose of changing the angle can be also achieved by controlling the light-dark luminous intensity of the light distribution lens 1 under each light type; otherwise, the function of adjusting the angle can also be achieved by forcibly occluding and interfering with the light types by the reflective baffles 3, so that after compensation of different angles and intensities, any light type can be obtained from the light types obtained after fixed-focus and cooperative complementation of any number of light distribution lenses 1 with arbitrary shapes; therefore, the brightness distribution and the shape distortion of the light spot of the combined light type can be accurately adjusted, so that the needs in the specific application scenes, such as stage illumination, building illumination or local illumination in a specific area, are met, and the precise control of the light type is effectively improved.

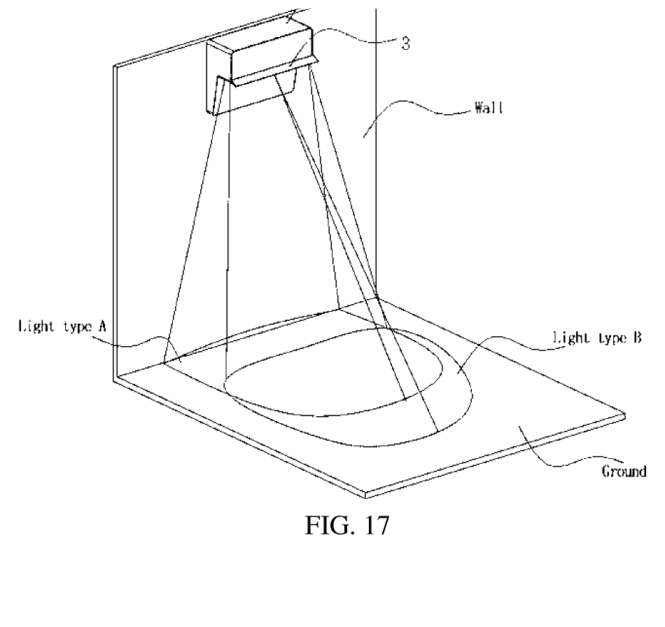

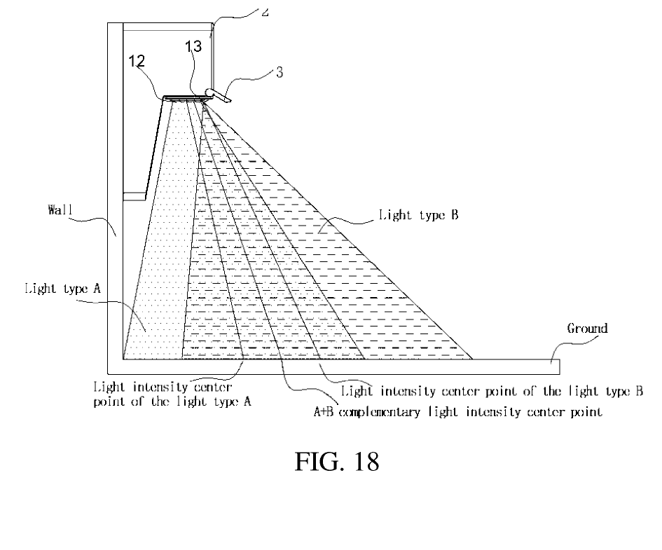

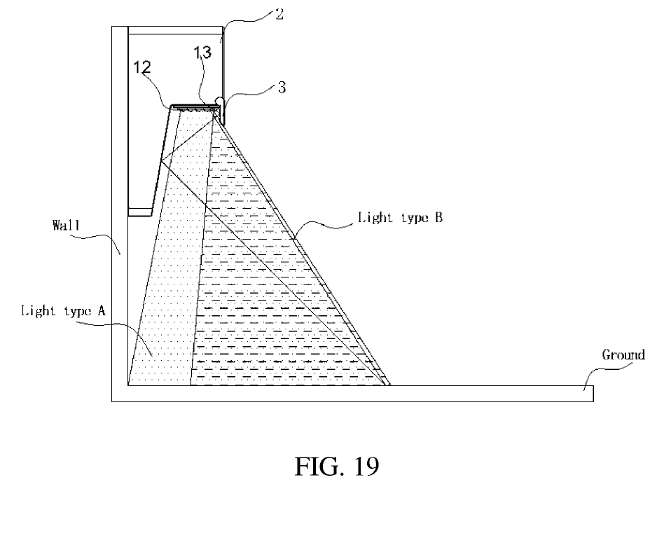

With reference to the FIG. 16-19, in an embodiment, the light distribution lenses 1 include a third-light-type light distribution lens 12 and a fourth-light-type light distribution lens 13; the third-light-type light distribution lens 12 and the fourth-light-type light distribution lens 13 are connected, and the third-light-type light distribution lens 12 and the fourth-light-type light distribution lens 13 form an integrated component.

In the embodiment, the light distribution lenses 1 include the third-light-type light distribution lens 12 and the fourth-light-type light distribution lens 13, and the third-light-type light distribution lens 12 and the fourth-light-type light distribution lens 13 can emit a plurality of the same or different light spots respectively; therein, in an exemplary embodiment, one third-light-type light distribution lens 12 and one fourth-light-type light distribution lens 13 are provided respectively, the third-light-type light distribution lens 12 and the fourth-light-type light distribution lens 13 are connected, the size of the third-light-type light distribution lens 12 is bigger than that of the fourth-light-type light distribution lens 13, and the third-light-type light distribution lens 12 and the fourth-light-type light distribution lens 13 form the integrated component; the two light distribution lenses 1 with different sizes are integrated to form the integrated component, so that the structure of a lighting device is simplified, the volume and the space occupation of the whole light distribution apparatus for the lighting lamp can be reduced, the whole apparatus is more compact, and thus the internal space of the lamp body 2 is effectively utilized and the layout of each component of the light distribution apparatus for the lighting lamp is optimized.

Furthermore, the third-light-type light distribution lens 12 includes a third circuit board 120, a third lens 121 and a plurality of third lighting lamp beads 122, the third circuit board 120, the third lens 121 and the plurality of third lighting lamp beads 122 are arranged in a manner of corresponding to one another, the third circuit board 120 is fixedly connected to the lamp body 2 and is electrically connected with the control device, the third lens 121 is positioned on one side, far away from the lamp body 2, of the third circuit board 120 and is connected with the third circuit board 120, the third lighting lamp beads 122 are positioned between the third circuit board 120 and the third lens 121, and the plurality of third lighting lamp beads 122 are electrically connected to the third circuit board 120 in an array arrangement; the fourth-light-type light distribution lens 13 includes a fourth circuit board 130, a fourth lens 131 and a plurality of fourth lighting lamp beads 132, the fourth circuit board 130, the fourth lens 131 and the plurality of fourth lighting lamp beads 132 are arranged in a manner of corresponding to one another, the fourth circuit board 130 is fixedly connected to the lamp body 2 and is electrically connected with the control device, the fourth lens 131 is positioned on one side, far away from the lamp body 2, of the fourth circuit board 130 and is connected with the fourth circuit board 130, the fourth lighting lamp beads 132 are positioned between the fourth circuit board 130 and the fourth lens 131, and the plurality of fourth lighting lamp beads 132 are electrically connected to the fourth circuit board 130 in a manner of being arranged along the width direction of the lamp body 2; therein, the third circuit board 120 and the fourth circuit board 130 together form a circuit board to form an integrated component, the third lens 121 and the fourth lens 131 together form a lens to form an integrated component, the fourth lens 131 is arranged on one side of the third lens 121, the third lens 121 is provided with a plurality of spherical convex lenses corresponding to the plurality of third lighting lamp beads 122, and the fourth lens 131 is provided with a strip-shaped convex lens corresponding to the fourth lighting lamp beads; through the integrated design of the third circuit board and the fourth circuit board 130 and the integrated design of the third lens 121 and the fourth lens 131, the number of components can be reduced, the assembling process can be simplified, and the production efficiency can be improved; and through the combination of the spherical convex lenses and the strip-shaped convex lens, the light path is optimized and the lighting efficiency and the lighting uniformity are improved.

Furthermore, when the third-light-type light distribution lens 12 emits A-light-type light and the fourth-light-type light distribution lens 13 emits B-light-type light respectively, the light type A is a short-distance projection light type and the light type B is a long-distance projection light type, and the two light types have the own light projection paths and light distribution angles; if only the A-light-type light is output through switch control, the lighting lamp obtains a short-distance light projection angle, and if only the B-light-type light is output through switch control, the lighting lamp obtains a long-distance light projection angle; in addition, when the two light types are turned on at the same time, a larger light projection angle can be obtained through complementation; moreover, if the light intensities output by the two light types are the same, the light intensity center point after complementation shifts to a half position from a light intensity center point A to a light intensity center point B; therefore, after arbitrary complementation, the light intensity center can only be positioned between the original light intensity center points of the two light types, and the shift of the light intensity center point represents the change of the light distribution angle, so that the light intensity center can be shifted by controlling the light-dark intensities output by the two light types to achieve the purpose of controlling the angle; for example, if the output light intensity of the light type A is larger than that of the light type B, the light intensity center point after complementation shifts towards the light intensity center point A, and until the output light intensity of the light type B is equal to 0, the light intensity center point after complementation is equal to the light intensity center point of the light type A; on the contrary, the light intensity center point after complementation shifts towards the light intensity center point of the light type B; therefore, the purpose of controlling the angle can be achieved by controlling the ratio of the output light intensities of the light type A and the light type B; and the way of controlling the ratio can be achieved not only by changing the lightness and darkness, but also by controlling the total brightness or the number ratio of the light distribution lenses 1 under each light type, so that the change of the light projection angle can be realized only by adjusting the light intensity ratio without changing the structures or the positions of the light distribution lenses 1, and thus different lighting needs are met.

Furthermore, the function of adjusting the angle can also be achieved by forcibly occluding and interfering with the light type B by the reflective baffles 3; a part of the light intensity of the light type B is occluded and interfered by the reflective baffles 3, and the light intensity of the occluded part is reflected for many times and then projected to the ground, so that through comparison with the complementary light type that is not occluded, an obvious angle change is achieved; therefore, the purpose of adjusting the angle can also be achieved by controlling the amount of light occluded by the reflective baffles 3, so that the projection direction of the occluded light can be finely controlled, and thus the angle adjustment of illumination is realized and different lighting needs and spot designs are met.

With reference to the FIG. 2 and the FIG. 16, in an embodiment, the light distribution apparatus further includes the reflective baffles 3; the reflective baffles 3 are movably connected at the corners between one sides, where the light distribution lenses 1 are arranged, and the adjacent sides thereof; and the reflective baffles 3 incline towards the directions away from the light distribution lenses 1.

In the embodiment, the light distribution apparatus for the lighting lamp further includes the reflective baffles 3; the reflective baffles 3 are movably connected at the corners between one sides, where the light distribution lenses 1 are arranged, and the adjacent sides thereof; and the reflective baffles 3 incline towards the directions away from the light distribution lenses 1; the reflective baffles 3 are used for adjusting and optimizing the distribution of the light to achieve a more accurate light distribution effect; through free combination of different light distribution lenses 1, the output of various combined light types are realized; the compensation angle of the light emitted by the light distribution lenses 1 is adjusted by the interference of the reflective baffles 3; when a light source cannot run through the baffles, reflective deviation occurs; the final lighting light distribution angle can be changed by adjusting the occluding positions of the reflective baffles 3; the purpose of adjusting the compensation angle can also be achieved by changing the focus shift positions of the light distribution lenses 1; the lens bodies of the light distribution lenses 1 are shifted relative to the left and right positions, which leads to the change of the focus positions of the original lenses and the accompanying change of the light type, so that the purpose of adjusting the angle is achieved; therefore, through adjustment of the occluding positions of the reflective baffles 3, the reflection angle of the light can be accurately controlled, so that accent illumination in the specific area is achieved or dazzle light in some areas is avoided; in such a manner, the positions of the baffles can be gradually changed to finely adjust the direction of the light beam to achieve very accurate light control; in addition, the width and the direction of the light beam can be adjusted by changing the focus positions of the light distribution lenses 1; and the left-and-right shift of the lens bodies of the light distribution lenses 1 leads to the focus change which causes the change of the light type, so that different lighting needs can be met and the lighting needs are effectively improved.

With reference to the FIG. 2-19, in an embodiment, the first-light-type light distribution lens or the third-light-type light distribution lens has a first cambered lens array and is used for generating a first-type light spot; each second-light-type light distribution lens or the fourth-light-type light distribution lens has a second cambered lens array and is used for generating a second-type light spot; and the first-type light spot is a wide-angle light spot and the second-type light spot is a spotlight light spot.

In the embodiment, the first-light-type light distribution lens or the third-light-type light distribution lens is provided with the first cambered lens array, and the array is specially designed for generating the wide-angle light spot which has a large coverage range and is suitable for scenes needing wide lighting areas; each second-light-type light distribution lens or the fourth-light-type light distribution lens is provided with the second cambered lens array, and the array is specially designed for generating the spotlight light spot which has high concentrated brightness and is suitable for scenes requiring concentrated illumination or long-distance illumination; the control system determines a needed light spot type according to the input of the user or an environmental detection result; moreover, the user can select a needed lighting mode through an interface, or the system can make automatic selection according to an ambient light sensor; according to the determined light spot type, the control system adjusts the brightness of the light source and the luminous intensities of the light distribution lenses 1 to match the needed lighting effect; if wide-angle illumination is needed, the control system activates the first-light-type light distribution lens or the third-light-type light distribution lens; if spotlight illumination is needed, the control system activates the second-light-type light distribution lenses or the fourth-light-type light distribution lens; when a more complicated lighting effect is needed, the control system can simultaneously activate the first-light-type light distribution lens or the third-light-type light distribution lens as well as second-light-type light distribution lenses or the fourth-light-type light distribution lens; through combination thereof, a mixed-type light spot is generated, so that the control system can flexibly switch between the wide-angle light spot and the spotlight light spot according to different lighting needs, so that suitability for various scenes is achieved; furthermore, the system can automatically detect the ambient light and adjust the appropriate light spot type according to the actual needs, so that with no need of manual intervention of the user, the convenience and the intelligence degree during use are improved.

With reference to the FIG. 2, in an embodiment, the first-light-type light distribution lens 10 includes a first circuit board 101, and a first lens 102 and a plurality of first lighting lamp beads 103 arranged in an array, which are connected to the first circuit board 101; the first circuit board 101 is connected with the lamp body 2; the first lens 102 is positioned on one side, far away from the lamp body 2, of the first circuit board 101; the first lighting lamp beads 103 are positioned between the first circuit board 101 and the first lens 102; and spherical convex lenses corresponding to the plurality of first lighting lamp beads 103 are arranged on one side, far away from the first circuit board 101, of the first lens 102.

In the embodiment, the first-light-type light distribution lens 10 includes the first circuit board 101, the first lens 102 and the plurality of first lighting lamp beads 103; the first circuit board 101, the first lens 102 and the plurality of first lighting lamp beads 103 are arranged in a manner of corresponding to one another; the first circuit board 101 is fixedly connected to the lamp body 2 and is electrically connected with the control device; the first lens 102 is positioned on the side, far away from the lamp body 2, of the first circuit board 101 and is connected with the first circuit board 101; the first lighting lamp beads 103 are positioned between the first circuit board 101 and the first lens 102; the plurality of first lighting lamp beads 103 are electrically connected to the first circuit board 101 in an array arrangement; in addition, the corners of the four sides of the first circuit board 101 are chamfered square multilayer PCBs (Printed Circuit Board), the first lighting lamp beads 103 are preferably LED (Light Emitting Diode) lamp beads, and the material of the first lens 102 is preferably polymethyl methacrylate, polystyrene, polycarbonate and etc.; moreover, a plurality of spherical convex lenses are arranged on the side, far away from the first circuit board 101, of the first lens 102, the spherical convex lenses are protruded in a direction away from the first circuit board 101, and the plurality of spherical convex lenses correspond to the plurality of first lighting lamp beads 103; and through the spherical convex lenses, the light from the plurality of first lighting lamp beads 103 can be gathered together to form a more concentrated and powerful light spot, so that the brightness and the light-gathering effect during illumination are improved, the light can be more concentrated, and thus the projection distance of the light is increased and the long-range performance during the illumination is improved.

With reference to the FIG. 2, in an embodiment, the second-light-type light distribution lens 11 includes a second circuit board 110, and a second lens 111 and a plurality of second lighting lamp beads 112 arranged in the width direction of the lamp body 2, which are connected to the second circuit board 110; the second circuit board 110 is connected with the lamp body 2; the second lens 111 is positioned on one side, far away from the lamp body 2, of the second circuit board 110; the second lighting lamp beads 112 are positioned between the second circuit board 110 and the second lens 111; and a strip-shaped convex lens corresponding to the second lighting lamp beads 112 is arranged on one side, far away from the second circuit board 110, of the second lens 111.

In the embodiment, the second-light-type light distribution lens 11 includes the second circuit board 110, the second lens 111 and the plurality of second lighting lamp beads 112; the second circuit board 110, the second lens 111 and the plurality of second lighting lamp beads 112 are arranged in a manner of corresponding to one another; the second circuit board 110 is fixedly connected to the lamp body 2 and is electrically connected with the control device; the second lens 111 is positioned on the side, far away from the lamp body 2, of the second circuit board 110 and is connected with the second circuit board 110; the second lighting lamp beads 112 are positioned between the second circuit board 110 and the second lens 111; the plurality of second lighting lamp beads 112 are electrically connected to the second circuit board 110 in a manner of being arranged along the width direction of the lamp body 2; in addition, the corners of the four sides of the second circuit board 110 are chamfered rectangular multilayer PCBs (Printed Circuit Board), the second lighting lamp beads 112 are preferably LED (Light Emitting Diode) lamp beads, and the material of the second lens 111 is preferably polymethyl methacrylate, polystyrene, polycarbonate and etc.; moreover, the strip-shaped convex lens is arranged on the side, far away from the second circuit board 110, of the second lens 111, the strip-shaped convex lens is protruded in a direction away from the second circuit board 110, the strip-shaped convex lens is positioned on the middle part of the second lens 111, and the length of the strip-shaped convex lens is equal to that formed by the plurality of the second lighting lamp beads 112 to achieve mutual correspondence thereof; through reflection and refraction of the strip-shaped convex lens, the distribution of the light can be adjusted in an auxiliary manner, so that the lighting uniformity is improved, the appearance of too strong or too weak light spot is avoided, and thus the illumination is more uniform and a wider area is covered; and moreover, the strip-shaped convex lens is arranged along the width direction of the lamp body 2, so that the space can be utilized more effectively, the light can be better guided to the area that needs to be illuminated, and improvement on the lighting efficiency of the system is facilitated.

The above descriptions are only the preferred embodiments of the invention, which do not limit the patent scope of the invention; and equivalent structure transformations or equivalent process transformations obtained from the contents of the specification and the drawings of the invention, or direct or indirect application to other related technical fields are equally included in the patent protection scope of the invention.

1. A light distribution method for a lighting lamp, wherein the lighting lamp comprises at least two light distribution lenses, and each light distribution lens emits the same or different light spots; and the light distribution method comprises the following steps:
acquiring a light distribution requirement needed by a target lighting area;
selecting corresponding target light distribution lenses from the light distribution lenses based on the light distribution requirement; and
controlling the luminous angle and/or the luminous intensity of each target light distribution lens according to the light distribution requirement to output a combined light type.

2. The light distribution method for the lighting lamp according to claim 1, wherein the step of acquiring the light distribution requirement needed by the target lighting area comprises the following sub-steps:
acquiring the purpose and the environmental characteristics of the target lighting area;
determining a needed lighting effect according to the purpose and the environmental characteristics; and
selecting the types and the number of the target light distribution lenses for the target lighting area based on the lighting effect.

3. The light distribution method for the lighting lamp according to claim 2, wherein the step of controlling the luminous angle and/or the luminous intensity of each target light distribution lens according to the light distribution requirement comprises the following sub-steps:
acquiring a light spot type, a lighting range and a brightness level that are needed based on the lighting effect; and
controlling the luminous angle and/or the luminous intensity of each target light distribution lens based on the light spot type, the lighting range and the brightness level.

4. The light distribution method for the lighting lamp according to claim 1, wherein the step of controlling the luminous angle and/or the luminous intensity of each target light distribution lens according to the light distribution requirement to output a combined light type comprises the following sub-steps:
setting a specific luminous angle parameter range and/or a specific luminous intensity parameter range for each target light distribution lens according to the light distribution requirement;
acquiring a target luminous angle parameter and/or a target luminous intensity parameter of the target light distribution lens within the luminous angle parameter range and/or the luminous intensity parameter range based on the environmental conditions and the usage scenes of the target lighting area; and
controlling the luminous angle and/or the luminous intensity of each target light distribution lens according to the target luminous angle parameter and/or the target luminous intensity parameter to enable each target light distribution lens to achieve the needed luminous effect in the target lighting area to generate the combined light type meeting the light distribution requirement.

5. A light distribution apparatus for a lighting lamp, wherein the light distribution apparatus comprises a lamp body, a control device and at least two light distribution lenses;
the light distribution lenses are arranged on one side, close to the target lighting area, of the lamp body, and each light distribution lens emits the same or different light spots; and
the control device is connected with the light distribution lenses, and is used for controlling the luminous angle and the luminous intensity of each target light distribution lens according to an actual light distribution requirement to output a combined light type.

6. The light distribution apparatus for the lighting lamp according to claim 5, wherein the light distribution lenses comprise a first-light-type light distribution lens and second-light-type light distribution lenses; and the first-light-type light distribution lens and the second-light-type light distribution lenses are arranged at intervals, so that the first-light-type light distribution lens and the second-light-type light distribution lenses are separated components.

7. The light distribution apparatus for the lighting lamp according to claim 5, wherein the light distribution lenses comprise a third-light-type light distribution lens and a fourth-light-type light distribution lens; the third-light-type light distribution lens and the fourth-light-type light distribution lens are connected; and the third-light-type light distribution lens and the fourth-light-type light distribution lens form an integrated component.

8. The light distribution apparatus for the lighting lamp according to claim 5, wherein the light distribution apparatus further comprises reflective baffles; the reflective baffles are movably connected at the corners between one sides, where the light distribution lenses are arranged, and the adjacent sides thereof; and the reflective baffles incline towards the directions away from the light distribution lenses.

9. The light distribution apparatus for the lighting lamp according to claim 6, wherein the first-light-type light distribution lens comprises a first circuit board, and a first lens and a plurality of first lighting lamp beads arranged in an array, which are connected to the first circuit board; the first circuit board is connected with the lamp body; the first lens is positioned on one side, far away from the lamp body, of the first circuit board; the first lighting lamp beads are positioned between the first circuit board and the first lens; and spherical convex lenses corresponding to the plurality of first lighting lamp beads are arranged on one side, far away from the first circuit board, of the first lens.

10. The light distribution apparatus for the lighting lamp according to claim 6, wherein the second-light-type light distribution lens comprises a second circuit board, and a second lens and a plurality of second lighting lamp beads arranged in the width direction of the lamp body, which are connected to the second circuit board; the second circuit board is connected with the lamp body; the second lens is positioned on one side, far away from the lamp body, of the second circuit board; the second lighting lamp beads are positioned between the second circuit board and the second lens; and a strip-shaped convex lens corresponding to the second lighting lamp beads is arranged on one side, far away from the second circuit board, of the second lens.
